(19) United States
(12) Patent Application Publication
(10) Pub. No.: US 2024/0064509 A1
(43) Pub. Date: Feb. 22, 2024

(54) AMF RE-ALLOCATION HANDLING

(71) Applicant: Telefonaktiebolaget LM Ericsson (PUBL), Stockholm (SE)

(72) Inventors: Prajwol Kumar Nakarmi, SOLLENTUNA (SE); Vlasios Tsiatsis, STOCKHOLM (SE); Monica Wifvesson, LUND (SE)

(21) Appl. No.: 18/260,909

(22) PCT Filed: Dec. 20, 2021
(86) PCT No.: PCT/EP2021/086736

§ 371 Date: Jul. 10, 2023

Related U.S. Application Data
(60) Provisional application No. 63/135,893, filed on Jan. 11, 2021.

(51) Int. Cl. H04W 12/041; H04W 12/0433; H04W 12/069; H04W 12/61

(52) U.S. Cl. CPC H04W 12/041; H04W 12/0433; H04W 12/069; H04W 12/61

(57) ABSTRACT

A method performed by a wireless device is provided. The method comprises identifying that an Access and Mobility Management Function (AMF) relocation procedure with re-route via a Radio Access Network (RAN) node is being performed for the wireless device and generating a key associated with a primary authentication of the wireless device. The method further comprises using the key for performing a Non Access Stratum Security Mode Control (NAS SMC) procedure with a first network node operating as a target AMF, and wherein the use of the key by the wireless node is restricted such that the wireless device is restricted from using the key for at least one procedure other than the NAS SMS procedure with the first network node operating as the target AMF.

### TECHNICAL FIELD

The present disclosure relates generally to communications, and more particularly to communication methods and related devices and nodes supporting AMF re-allocation handling.

### BACKGROUND

On a very high level, mobile networks standardized by 3rd Generation Partnership Project (3GPP) can be said to comprise of a user equipment (UE), radio access network (RAN), and core network (CN). FIG. 1 illustrates a simplified mobile network that includes these elements. The UE is a mobile device used by the user to wirelessly access the network. The RAN comprises of base stations (BSs) which are responsible for providing wireless radio communication to the UE and connecting the UE to the core network. The CN comprises of several types of core network functions which are responsible for various functions such as handling the mobility of the UE, interconnecting to data network, packet routing and forwarding, among other responsibilities.

Mobile networks are operated, and their services are offered by the so-called mobile network operators (MNOs). To use a particular mobile network offered by a particular MNO, users are required to have a contractual relationship with the particular MNO. The relationship is generally called the subscription.

In simple terms, the business model works as follows. The MNOs provide services to the users with valid subscriptions. These users use the services, which may include for example, e.g., sending SMS messages, making phone calls, and getting internet access. The MNOs charge these users for the services they have used through the MNOs' billing or charging systems. The users pay according to the billed amount.

This business model is supported by several security features built into the mobile networks. For example, the network can authenticate the users and determine if they have valid subscriptions; the traffic belonging to services such as SMS messaging, phone calls, internet data, are transported in secure way so that the users are billed correctly according to their usage of the traffic.

The traffic itself is of two types in general, one is control plane (CP) and another is user plane (UP). The control plane traffic is used for management of the traffic, and user plane traffic carries the actual data. The secure transport of the traffic is achieved by confidentiality/ciphering and integrity protection. Confidentiality/ciphering in this context means encryption of messages, which makes it infeasible for unauthorized parties to decrypt and read the original message. Integrity protection in this context means the sender adding a security token or a message authentication code (MAC) to the message that the receiver can verify, which makes it infeasible for unauthorized parties to tamper the original message without the receiver detecting the tampering.

A UE is typically connected to a single base station in order to use the mobile network services such phone calls, messaging, and data transmissions. When a UE does not have any data to send its connection is idle.

For the UE to use a network, a registration procedure takes place as a first step. The detailed registration procedure is outlined in 3GPP TS 23.502[1] (e.g. clause “4.2.2.2.2 General Registration”) as illustrated in FIGS. 2A, 2B and 2C.

Clause “4.2.2.2.3 Registration with Access and Mobility Management Function (AMF) re-allocation” in 3GPP TS 23.502 v.15.11.0 covers the case of an AMF re-allocation. The AMF re-allocation comes into play when the UE cannot be served by the Initial AMF which initially served the UE, due to reasons such as strict requirements on network slicing or AMF set deployment constraints. FIG. 3 illustrates the AMF re-allocation procedure according to 3GPP TS 23.502 v15.11.0, clause 4.2.2.2.3.

Certain problems exist. For example, when a source AMF transfers a NAS security context to a target AMF, there is no way to ensure that the NAS security context is not misused, which is a problem. The misuse could happen because of a badly implemented RAN node, compromised RAN node, compromised NG-AP interface or unprotected NG-AP interface.

Furthermore, the currently known solutions do not ensure that the initial Registration Request message sent by the UE is received by target AMF untampered.

### SUMMARY

Accordingly, exemplary embodiments of the present disclosure address these and other problems, issues, and/or difficulties associated AMF re-allocation handling, including security of use of a NAS security context.

Thus, according to a first aspect, a method performed by a wireless device is provided. The method comprises identifying that an Access and Mobility Management Function (AMF) relocation procedure with re-route via a Radio Access Network (RAN) node is being performed for the wireless device and generating a key associated with a primary authentication of the wireless device. The method further comprises using the key for performing a Non Access Stratum Security Mode Control (NAS SMC) procedure with a first network node operating as a target AMF, and wherein the use of the key by the wireless node is restricted such that the wireless device is restricted from using the key for at least one procedure other than the NAS SMS procedure with the first network node operating as the target AMF.

According to some embodiments, the key is a K_{AMF}.

According to some embodiments, the method further comprises receiving, from the first network node, a first message comprising a NAS SMC message.

According to some embodiments, the AMF relocation procedure is identified by the wireless device based on the first message.

According to some embodiments, the AMF relocation procedure is identified by the wireless device based on a content of the first message.

According to some embodiments, the AMF relocation procedure is identified by the wireless device based on a type of the first message.

According to some embodiments, the method further comprises receiving a second message comprising a primary authentication message.

According to some embodiments, the AMF relocation procedure is identified by the wireless device based on the primary authentication message being received after the first message comprising the NAS SMC message.

According to some embodiments, the AMF relocation procedure is identified by the wireless device based on the primary authentication message being received before a threshold amount of time has lapsed after the NAS SMC message was received.

According to some embodiments, the first network node comprises a gNodeB (gNB) or Next Generation eNodeB (ng-eNB).

According to some embodiments, the first network node comprises a core network node.

According to some embodiments, the method further comprises setting a count to a value, and refusing to accept a third message associated with the key based on the count being at the value. In some embodiments, the value may comprise a maximum value for the count.

According to some embodiments, the third message comprises a NAS message.

According to some embodiments, the wireless device is restricted from using the key for any procedure other than the NAS SMS procedure.

According to some embodiments, the wireless device comprises a user equipment (UE).

According to a second aspect, a wireless device comprising processing circuitry configured to perform any of the methods of the first aspect is provided.

According to a third aspect, a computer program comprising instructions which when executed on a computer perform any of the methods of the first aspect is provided. Further, a computer program product comprising a computer program, the computer program comprising instructions which when executed on a computer perform any of the methods of the first aspect is provided. A non-transitory computer readable medium storing instructions which when executed by a computer perform any of the methods of the first aspect is also provided.

According to a fourth aspect, a method performed by a first network node operating as a target Access and Mobility Management Function (AMF) is provided. The method comprises generating a key associated with a primary authentication of the wireless device, and using the key for performing a Non Access Stratum Security Mode Control (NAS SMC) procedure. The use of the key by the first network node is restricted such that the first network node is restricted from using the key for at least one procedure other than the NAS SMS procedure.

According to some embodiments, the key is a K_{AMF}.

According to some embodiments, the method further comprises receiving, from the wireless device, a first message associated with an AMF relocation procedure from a source AMF to the first network node operating as the target AMF, wherein the key is generated in response to receiving and/or based on the first message from the wireless device.

According to some embodiments, the method further comprises receiving, from a second network node, a second message, and identifying the AMF relocation procedure based on the second message received from the second network node.

According to some embodiments, the AMF relocation procedure is identified based on a content of the second message. The second message may, in some embodiments, comprise at least one of a security context, an indicator indicating that the first network node is to derive the key.

According to some embodiments, the AMF relocation procedure is identified based on a type of the second message. The type of the second message may be an initial user equipment message, in some embodiments.

According to some embodiments, the second network node comprises a gNodeB (gNB) or Next Generation eNodeB (ng-eNB).

According to some embodiments, the second node comprises a core network node.

According to some embodiments, the method further comprises setting a count to a value, and refusing to accept a third message based on the count being at the value. In some examples, the value may comprise a maximum value for the count.

According to some embodiments, the third message comprises a NAS message.

According to some embodiments, the first network node is restricted from using the key for any procedure other than the NAS SMS procedure.

According to a fifth aspect, a network node comprising processing circuitry configured to perform any of the methods of the fourth aspect is provided.

According to a sixth aspect, a computer program comprising instructions which when executed on a computer perform any of the methods of the fourth aspect. Further, a computer program product comprising computer program, the computer program comprising instructions which when executed on a computer perform any of the methods of the fourth aspect is provided. A non-transitory computer readable medium storing instructions which when executed by a computer perform any of the methods of the fourth aspect is also provided.

According to a seventh aspect, a method by a first network node operating as a target Access and Mobility Management Function (AMF) is provided. The method comprises receiving, from a wireless device, a first message associated with an AMF relocation procedure from a source AMF to the first network node operating as the target AMF, and receiving, from the source AMF, a second message associated with the AMF relocation procedure. The method further comprises using the first message rather than the second message to construct a response message to the wireless device.

According to some embodiments, the first message comprises an indicator, and wherein the first network node determines to use the first message from the wireless device rather than the second message from the source AMF to construct the response message. The indicator may, in some examples, comprise a request initial Network Access Stratum (NAS) flag.

According to some embodiments, the first message comprises a NAS Security Mode Command (NAS SMC) message.

According to some embodiments, the second message comprises an initial user equipment (UE) message.

According to some embodiments, the initial UE message comprises at least one of a complete registration request, a 5G NAS security context, and a keyAmfHDerivationInd.

According to some embodiments, the source AMF is associated with a second network node.

According to some embodiments, the second network node comprises a gNodeB (gNB) or Next Generation eNodeB (ng-eNB).

According to some embodiments, the first network node comprises a gNodeB (gNB) or Next Generation eNodeB (ng-eNB).

According to some embodiments, the method further comprises determining to use the first message rather than the second message to construct the response message based on the first message.

According to some embodiments, the method further comprises constructing the response message based on the first message rather than the second message.

According to some embodiments, the method further comprises transmitting the response message to the wireless device.

According to some embodiments, the method further comprises any of the any of the steps of any of the methods of the fourth aspect.

According to an eight aspect, a network node comprising processing circuitry configured to perform any of the methods of the seventh aspect.

According to a ninth aspect, a computer program comprising instructions which when executed on a computer perform any of the methods of the seventh aspect is provided. Further, a computer program product comprising a computer program, the computer program comprising instructions which when executed on a computer perform any of the methods of the seventh aspect. A non-transitory computer readable medium storing instructions which when executed by a computer perform any of the methods of the seventh aspect is also provided.

According to a tenth aspect, a wireless device is provided. The wireless device comprises processing circuitry configured to perform any of the steps of any of the methods of the first aspect, and power supply circuitry configured to supply power to the wireless device.

According to an eleventh aspect, a network node is provided. The network node comprises processing circuitry configured to perform any of the steps of any of the methods of claims fourth and seventh aspects, and power supply circuitry configured to supply power to the network node.

According to a twelfth aspect, a wireless device is provided. The wireless device comprises an antenna configured to send and receive wireless signals, radio front-end circuitry connected to the antenna and to processing circuitry, and configured to condition signals communicated between the antenna and the processing circuitry. The processing circuitry is configured to perform any of the steps of any of the methods of the first aspect. The wireless device further comprises an input interface connected to the processing circuitry and configured to allow input of information into the wireless device to be processed by the processing circuitry, an output interface connected to the processing circuitry and configured to output information from the wireless device that has been processed by the processing circuitry, and a battery connected to the processing circuitry and configured to supply power to the wireless device.

According to a thirteenth aspect, a communication system including a host computer is provided. The communication system comprising processing circuitry configured to provide user data, and a communication interface configured to forward the user data to a cellular network for transmission to a wireless device, wherein the cellular network comprises a network node having a radio interface and processing circuitry, the network node's processing circuitry configured to perform any of the steps of any of the methods of the fourth and the seventh aspects.

According to a fourteenth aspect, a method implemented in a communication system including a host computer, a network node and a wireless device is provided. The method comprises at the host computer, providing user data, and at the host computer, initiating a transmission carrying the user data to the wireless device via a cellular network comprising the network node, wherein the network node performs any of the steps of any of the methods of the fourth and seventh aspects.

According to a fifteenth aspect, a wireless device configured to communicate with a network node, the wireless device comprising a radio interface and processing circuitry configured to performs the method of any of the fourteenth aspect.

According to a sixteenth aspect, a communication system including a host computer is provided. The communication system comprises processing circuitry configured to provide user data, and a communication interface configured to forward user data to a cellular network for transmission to a wireless device, wherein the wireless device comprises a radio interface and processing circuitry, the wireless device's components configured to perform any of the steps of any of the methods of the first aspect.

According to an eighteenth aspect, a method implemented in a communication system including a host computer, a network node and a wireless device, is provided. The method comprises at the host computer, providing user data, and at the host computer, initiating a transmission carrying the user data to the wireless device via a cellular network comprising the network node, wherein the wireless device performs any of the steps of the methods of the first aspect.

According to a nineteenth aspect, a communication system including a host computer is provided. The communication system comprises a communication interface configured to receive user data originating from a transmission from a wireless device to a network node, wherein the wireless device comprises a radio interface and processing circuitry, the wireless device's processing circuitry configured to perform any of the steps of any of the methods of the first aspect.

According to a twentieth aspect, a method implemented in a communication system including a host computer, a network node and a wireless device, is provided. The method comprises, at the host computer, receiving user data transmitted to the network node from the wireless device, wherein the wireless device performs any of the steps of any of the methods of the first aspect.

According to a twenty first aspect, a communication system including a host computer comprising a communication interface configured to receive user data originating from a transmission from a wireless device to a network node, wherein the network node comprises a radio interface and processing circuitry, the network node's processing circuitry configured to perform any of the steps of any of the methods of the fourth and seventh aspects is provided.

According to a twenty second aspect, a method implemented in a communication system including a host computer, a network node and a wireless device, is provided. The method comprises, at the host computer, receiving, from the base station, user data originating from a transmission which the network node has received from the wireless device, wherein the wireless device performs any of the steps of any of the methods of the first aspect.

These and other objects, features, and advantages of the present disclosure will become apparent upon reading the following detailed description in view of the drawings briefly described below.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates a simplified mobile network.

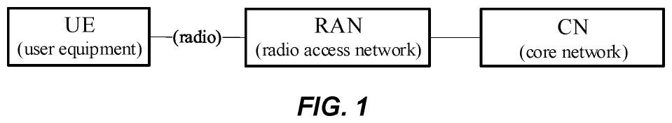

FIGS. 2A, 2B and 2C illustrate a general registration procedure.

FIG. 3 illustrates an AMF re-allocation procedure.

FIGS. 4A and 4B illustrate an AMF Re-Allocation with NAS message and 5G NAS Security Context Re-Route via RAN according to some embodiments.

FIG. 5 illustrates a method for the restricted use of a NAS security context transferred by an initial AMF to a target AMF according to some embodiments.

FIG. 6 illustrates methods and systems to ensure that the Registration Request message received by target AMF is untampered according to some embodiments.

FIG. 7 illustrates a wireless network, in accordance with some embodiments.

FIG. 8 illustrates an example network node, according to some embodiments.

FIG. 9 illustrates an example wireless device according to some embodiments.

FIG. 10 illustrates one embodiment of a UE in accordance with some embodiments.

FIG. 11 is a schematic block diagram illustrating a virtualization environment according to some embodiments.

FIG. 12 illustrates a telecommunication network connected via an intermediate network to a host computer in accordance with some embodiments.

FIG. 13 illustrates a host computer communicating via a base station with a user equipment over a partially wireless connection in accordance with some embodiments.

FIGS. 14-17 are flowcharts illustrating methods implemented in a communication system, in accordance with some embodiments.

FIG. 18 shows a method by a wireless device, according to certain embodiments.

FIG. 19 illustrates a schematic block diagram of a virtual apparatus in a wireless network.

FIG. 20 depicts a method by a first network node operating as a target AMF, according to some embodiments.

FIG. 21 illustrates a schematic block diagram of a virtual apparatus in a wireless network according to some embodiments.

FIG. 22 depicts another method by a first network node operating as a target AMF, according to some embodiments.

FIG. 23 illustrates a schematic block diagram of a virtual apparatus in a wireless network according to some embodiments.

### DETAILED DESCRIPTION

Exemplary embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

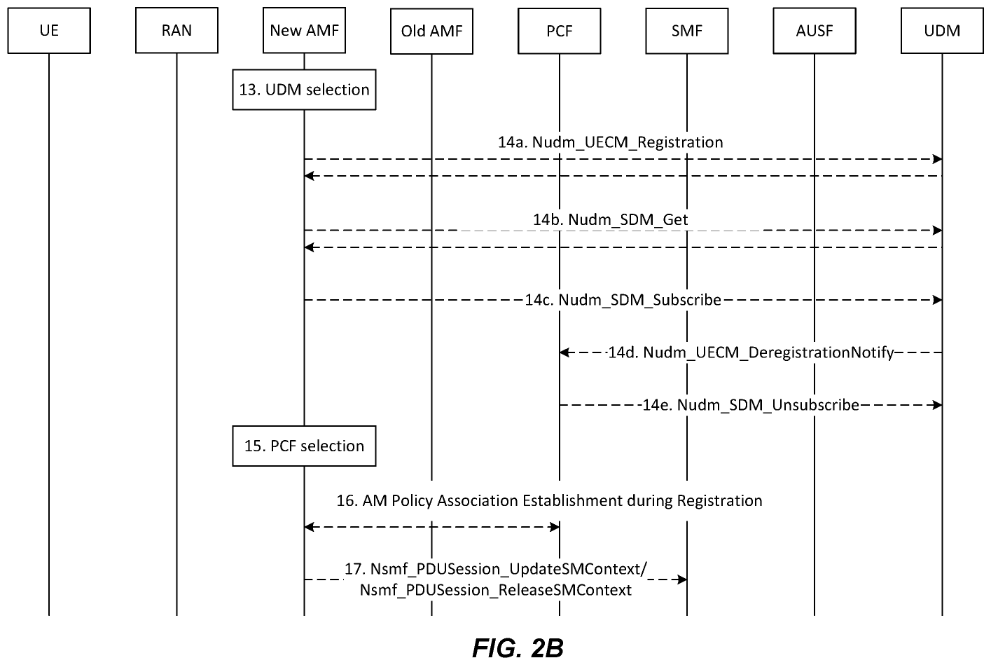

FIG. 3 illustrates the AMF re-allocation procedure according to 3GPP TS 23.502 v15.11.0, clause 4.2.2.2.3.

As shown in FIG. 3, (A) is a AMF re-allocation happening directly between AMFs, and (B) is a AMF re-allocation happening via RAN.

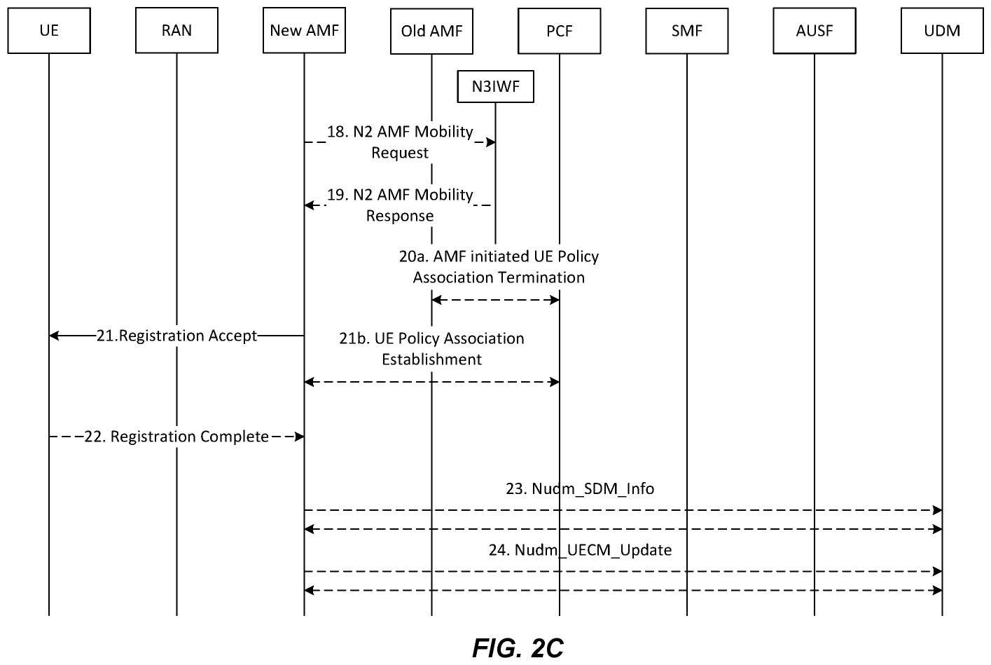

3GPP's security working group, called SA3, has now started a study in 3GPP TR 33.864, where a number of security solutions are studied in order to resolve the handling of the security in the scenario described in option (B) above. One of the solutions is described in solution #2 in clause 6.2 in 3GPP TR 33.864. FIG. 4 illustrates solution #2 as described in 3GPP TR 33.864.

As used herein, the Kamf is a key for the AMF in the serving network. The Kamf may be derived directly or indirectly from one or more anchor keys.

Before the Initial AMF re-routes the Registration Request (RR) message and the 5G NAS security context, the Initial AMF performs horizontal Kamf derivation of the current Kamf-0 and generates a new Kamf-1 key which is then routed via RAN to the Target AMF together with an indication of horizontal K_{AMF} derivation (i.e., keyAmfHDerivationInd). The current Kamf-0 is not rerouted via RAN to the Target AMF. This would ensure that the Target AMF (or any other intermediary network function or nodes) has no access to the Kamf-0 key used in the Initial AMF/old AMF.

The Initial AMF forwards the RR message, the 5G NAS security context including the Kamf-1 and the keyAmfHDerivationInd indicator unprotected to the Target AMF via RAN.

The new generated Kamf-1 key could be seen as a one-time key for the purpose of the AMF re-allocation. The Target AMF would then be mandated to establish a new further key Kamf-2 with the UE, which is not available to the Initial AMF and the RAN.

Because the Target AMF has received the keyAmfHDerivationInd indicator, the Target AMF runs a NAS SMC procedure with the UE, to take the new Kamf-1 key into use with the UE. The Target AMF is also mandated to initiate a new primary authentication with the UE to derive a new Kamf-2 when it has received the RR message from the RAN. The new primary authentication procedure is protected by the Kamf-1. This step would ensure that the Initial AMF has no access to the new Kamf-2 key (i.e. the Kamf key used in the Target AMF and the UE).

The Target AMF runs a new NAS SMC procedure with the UE to take the new Kamf-2 into use with the UE.

FIGS. 4A and 4B shows a method for AMF Re-Allocation with NAS message and 5G NAS Security Context Re-Route via RAN.

As shown in FIG. 4, the method comprises:

Step 1: The UE prepares a Registration Request message including 5G-GUTI and slicing information which could potentially cause an AMF re-allocation and its 5G-GUTI. The UE has a 5G NAS security context and protects therefore the Registration Request message.

Step 2: The RAN forwards the RR message to an Initial AMF.

Step 3/4: These steps may only take place if UE has indicated its 5G-GUTI in the Registration Request message. The Initial AMF contacts the old AMF and requests the 5G NAS security context from the old AMF. The old AMF may perform horizontal Kamf derivation of the Kamf key.

Step 5: The Initial AMF may initiate a new primary authentication. This step is optional. This step is mandatory if the UE has indicated its SUCI in the Registration Request message

Step 6: The Initial AMF initiates a NAS SMC. This step takes place if a prior primary authentication has taken place or if the old AMF has performed horizontal Kamf derivation of the Kamf key. The Initial AMF may include the request to the UE to include the complete Registration Request message by setting the flag “request initial NAS flag” if the old AMF has performed horizontal Kamf derivation of the Kamf key.

Step 7: The UE includes the complete RR message sent in step 1 in the NAS Security Mode Complete message. The RR message is both integrity protected and encrypted.

Step 8: If the Initial AMF needs UE's subscription information to decide whether to reroute the Registration Request and UE's slice selection subscription information was not provided by old AMF, the AMF selects a UDM as described in TS 23.501 [4], clause 6.3.8. the Initial AMF sends Nudm_SDM_Get to UDM.

Step 9: The UDM responds to Initial AMF with a Nudm_SDM_GetResponse. The AMF gets the Slice Selection Subscription data including Subscribed S-NSSAIs. The UDM responds with slice selection data to Initial AMF.

Step 10: If there is a need for slice selection, (see clause 5.15.5.2.1 of TS 23.501 [4]), e.g. the Initial AMF cannot serve all the S-NSSAI(s) from the Requested NSSAI permitted by the subscription information, the Initial AMF invokes the Nnssf_NSSelection_Get service operation from the NSSF by including Requested NSSAI.

Step 11: The NSSF performs the steps specified in point (B) in clause 5.15.5.2.1 of TS 23.501 [4]. The NSSF responds to Nnssf_NSSelection_Get to the Initial AMF.

Step 12: The Initial AMF decides to reroute the RR message to a Target AMF via RAN. The Initial AMF optionally performs horizontal Kamf derivation of Kamf-0 to generate a new Kamf-1. This step would ensure that target AMF has no access to the Kamf-0 key used in Initial AMF;

Step 13: The Initial AMF forwards the complete Registration Request message, the 5G NAS security context including the new Kamf-1 and the keyAmfHDerivationInd indicator to the RAN.

Step 14: The RAN confirms the reception of the RR message etc. to the Initial AMF.

Step 15: The RAN forwards the complete Registration Request message, the 5G NAS security context and keyAmfHDerivationInd indicator to the target AMF.

Step 16: If the target AMF has received the keyAmfHDerivationInd indicator, then the target AMF runs a NAS SMC procedure with the UE, to take the new Kamf-1 key into use with the UE.

Step 17: The target AMF initiates a new primary authentication with the UE to generate a new Kamf-2. The new primary authentication procedure is protected by the Kamf-1. This step would ensure that the Initial AMF has no access to the new Kamf-2 key generated between target AMF and the UE.

Step 18: The target AMF runs a new NAS SMC procedure with the UE to take the new Kamf-2 into use with the UE.

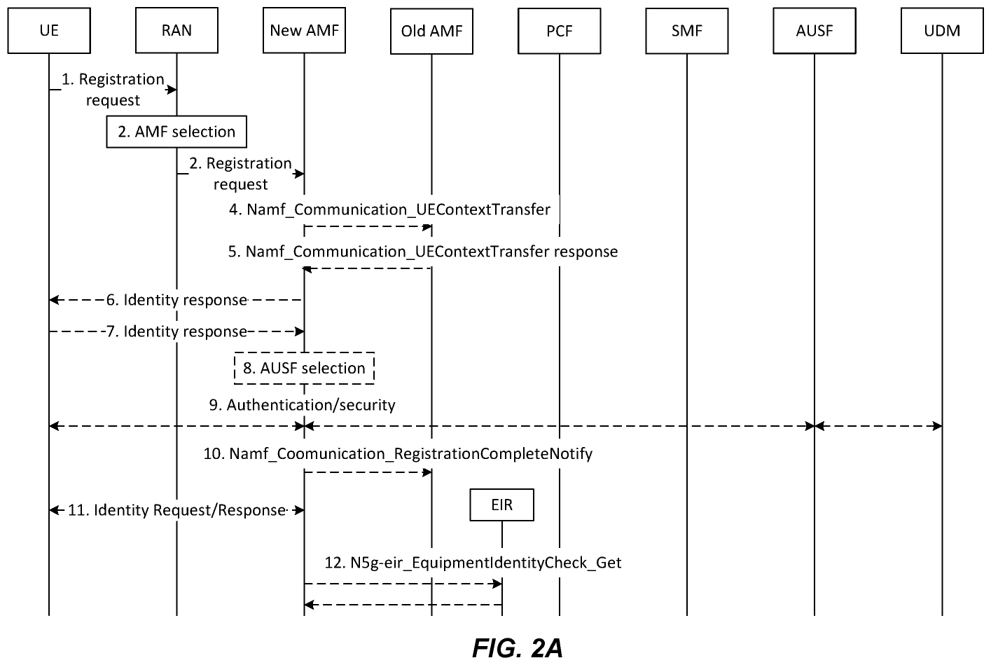

The AMF re-allocation procedure outlined in FIG. 3 results in the UE and Initial AMF sharing a security context after step 2 in FIG. 3 or after step 9 in FIG. 2. Therefore, encryption and integrity protection keys could be used for the secure communication between the UE and the Initial AMF. The last part of step 9 in FIG. 2 is the NAS Security Mode Command that takes the security context into use between the UE and the Initial AMF. After the NAS SMC procedure the Initial AMF receives the complete initial registration request which may have slicing information such a Network Slice Selection Assistance Information (NSSAI). Based upon this slicing information the Initial AMF may determine that it is not the right AMF to serve the UE and so performs a look up for an appropriate AMF (steps 6a, 6b in FIG. 3). A potentially problematic situation is case (B) in FIG. 3 when the Target AMF (the AMF that was discovered to fulfil the requirements to serve the UE with respect to slicing) cannot be contacted by the Initial AMF in order to transfer the security context shared between the UE and the Initial AMF. As a result, the target AMF will not have necessary security context and step 8 in FIG. 3 will be followed which imply that the Target AMF will try to authenticate the UE again by issuing an unprotected NAS message (AUTHENTICATION REQUEST, or AUTHRQ for short). According to the rules in TS 24.501 [2] (clause “4.4.4.2 Integrity checking of NAS signalling messages in the UE”), this unprotected AUTHRQ message will be dropped by the UE since it already has a security context with the network (with the Initial AMF though, not the Target AMF).

It may be observed that in the case 7(A) there is no problem since the security context is transferred from the Initial AMF to the Target AMF. Therefore, if the Target AMF decides to re-authenticate the UE, it has the security context with which it could protect the AUTHRQ.

As discussed above, problems exist with the prior art. For example, when a source AMF transfers a NAS security context to a target AMF, there is no way to ensure that the NAS security context is not misused, which is a problem. The misuse could happen because of a badly implemented RAN node, compromised RAN node, compromised NG-AP interface or unprotected NG-AP interface. Furthermore, the currently known solutions do not ensure that the initial Registration Request message sent by the UE is received by target AMF untampered.

Certain aspects of the present disclosure and their embodiments may provide solutions to these or other challenges. This disclosure shows improvements to solution #2 in TR 33.564 which is discussed above with respect to FIG. 4. For example, according to certain embodiments, methods and systems are provided such that the NAS security context transferred by the initial AMF to a target AMF to only be used for restrictive purpose. As another example, according to certain embodiments, methods and systems are provided to ensure that the Registration Request message received by target AMF is untampered.

Certain embodiments may provide one or more of the following technical advantages. For example, one technical advantage may be that certain embodiments restrict the use of the NAS security context transferred by the initial AMF to the target AMF. This may provide protection or mitigation against any entities possessing and misusing the Kamf-1.

As another example, a technical advantage may be that certain embodiments ensure that the Registration Request received by target AMF is untampered. This may provide protection or mitigation against any entities modifying the Registration Request during AMF reallocation with re-route via RAN.

Other advantages may be readily apparent to one having skill in the art. Certain embodiments may have none, some, or all of the recited advantages.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc.), O&M, OSS, SON, positioning node (e.g. E-SMLC), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

Meanings of the terms Kamf-0, Kamf-1, and Kamf-2 are given below:
Kamf-0: Kamf that is active between the UE and the initial AMF. This Kamf-0 is known to the initial AMF, but not to the target AMF. The RAN does not know Kamf-0 neither.
Kamf-1: New Kamf derived from Kamf-0 using horizontal Kamf derivation by the initial AMF. This Kamf-1 is transferred by the initial AMF to the target AMF via RAN. So, in principle, all the three entities—including the initial AMF, target AMF, and RAN—know Kamf-1.
Kamf-2: New Kamf derived by the target AMF after new primary authentication. This Kamf-2 is known to the target AMF; the initial AMF and the RAN do not know the Kamf-2.

Certain embodiments described herein provide improvements to solution #2 in TR 33.564 which is discussed above with respect to FIG. 4. For example, according to a first embodiment, methods and systems are provided such that the NAS security context transferred by the initial AMF to a target AMF to only be used for restrictive purpose. As another example, according to a second embodiment, methods and systems are provided to ensure that the Registration Request message received by target AMF is untampered.

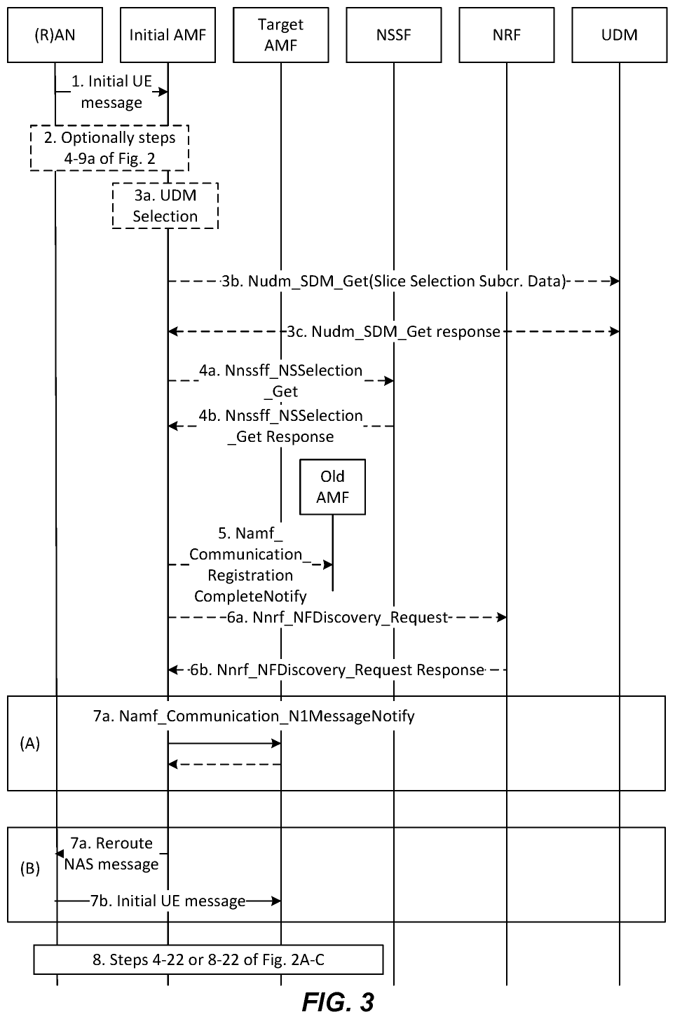

FIG. 5 illustrates a method for the restricted use of a NAS security context transferred by an initial AMF to a target AMF.

As proposed herein, according to certain embodiments, the use of Kamf-1 at the target AMF may be restricted. The said restriction may be achieved in steps as stated below:
a. The Target AMF determines that an AMF relocation with re-route via RAN is taking place.
   The said determination could be done by considering the type and/or content of NG-AP message from the RAN (gNB/ng-eNB). For example, Step 15 in FIG. 4 shows Initial UE message with contents: complete Registration Request, 5G NAS security context, and keyAMFHDerivationInd. At least the presence of 5G NAS security context could be an indication that AMF relocation with re-route via RAN is taking place. The type of message which is Initial UE message could also be an indication that AMF relocation with re-route via RAN is taking place.
b. The Target AMF restrictively uses the Kamf-1 only for the purpose of NAS Security Mode Control procedure and Authentication procedure; not for any other NAS procedure.
   This restricted use of the Kamf-1 can be standardized in 3GPP technical specifications like 33.501 or 24.501, for example, by stating one of: “The target AMF shall use the Kamf-1 only for NAS SMC and authentication procedure.”; “The target AMF shall use the Kamf-1 only for sending protected NAS Security Mode Command and Authentication Challenge/Request to the UE, and for receiving protected NAS Security Mode Complete and Authentication Response from the UE.”; “The target AMF shall not use the Kamf-1 for any other procedures than NAS SMC and authentication procedure”. Such restricted usage provides protection or mitigation against any entities possessing and misusing the Kamf-1.
   Another way for the Target AMF to restrictively use the Kamf-1 is that the Target AMF sets the uplink and downlink NAS COUNT values to maximum (that is, 2 power 28) or close to maximum (for example, 5 less than 2 power 28). Doing so means that the Target AMF will not accept any uplink NAS messages or accept only few such messages using the Kamf-1. Not accepting is because of replay protection feature and provides protection or mitigation against any entities possessing and misusing the Kamf-1.

According to certain embodiments, the use of Kamf-1 at the UE may additionally or alternatively be restricted. The said restriction may be achieved in steps as stated below:
a. The UE determines that an AMF relocation with re-route via RAN is taking place.
   The said determination could be done by considering the type and/or content of NAS message from the network. For example, Step 16 in FIG. 4 shows NAS SMC procedure in which the NAS Security Mode Command could be an indication that AMF relocation with re-route via RAN is taking place. Further, Step 17 in FIG. 4 shows Primary authentication procedure in which the UE received Authentication Challenge. The primary authentication immediately or soon after NAS SMC procedure could be an indication that AMF relocation with re-route via RAN is taking place.
b. The UE restrictively uses the Kamf-1 only for the purpose of NAS Security Mode Control procedure and Authentication procedure; not for any other NAS procedure.
   This restricted use of the Kamf-1 can be standardized in 3GPP technical specifications like 33.501 or 24.501, for example, by stating one of: “The UE shall use the Kamf-1 only for NAS SMC and authentication procedure.”; “The UE shall use the Kamf-1 only for sending protected NAS Security Mode Complete and Authentication Response to the AMF, and for receiving protected NAS Security Mode Command and Authentication Challenge/Request from the AMF.”; “The UE shall not use the Kamf-1 for any other procedures than NAS SMC and authentication procedure”. Such restricted usage provides protection or mitigation against any entities possessing and misusing the Kamf-1.
   Another way for the UE to restrictively use the Kamf-1 is that the UE sets the uplink and downlink NAS COUNT values to maximum (that is, 2 power 28) or close to maximum (for example, 5 less than 2 power 28). Doing so means that the UE will not accept any downlink NAS messages or accept only few such messages using the Kamf-1. Not accepting is because of replay protection feature and provides protection or mitigation against any entities possessing and misusing the Kamf-1.

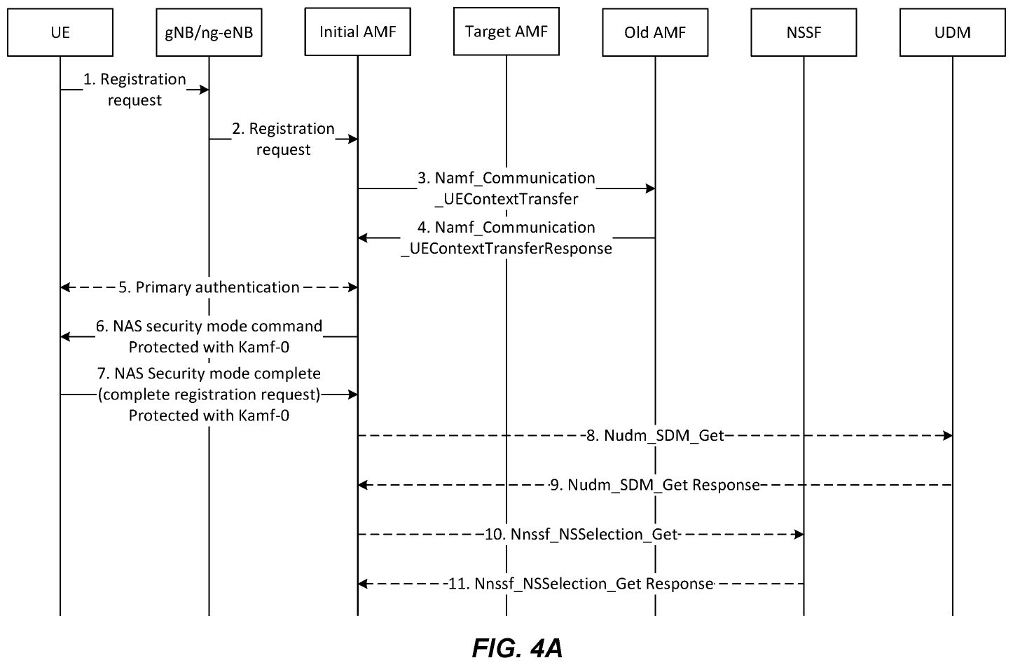

FIG. 6 illustrates methods and systems to ensure that the Registration Request message received by target AMF is untampered.

As proposed herein, according to certain embodiments, steps for ensuring that the Registration Request message received by the target AMP is untampered may include:
Step 1-17: Same as existing technique or any embodiment described herein.
Step 18: This is a modified step. While the target AMF runs NAS SMC procedure with the UE to take the new Kamf-2 into use, the target AMF shall include the request to the UE to include the complete Registration Request message in the NAS Security Mode Complete message by setting the flag “request initial NAS flag” in the NAS Security Mode Command message. The UE includes the complete Registration Request message (sent in step 1) in the NAS Security Mode Complete message to the target AMF. This means that the target AMF can ignore the Registration Request message rerouted via RAN and instead use the Registration Request received from the UE in the NAS Security Mode Complete message. Thus, protection or mitigation against any entities modifying the Registration Request is achieved.

Though described in the context of a RAN node (gNB/ng-eNB), it is recognized that any of the aforementioned techniques and embodiments are applicable in the case that the Registration Request and the security context are routed over a core network function instead of the RAN node (gNB/ng-eNB). Examples of core network functions to be used for routing the Registration Request and the security context as the AUSF, UDM, NSSF, AMF.

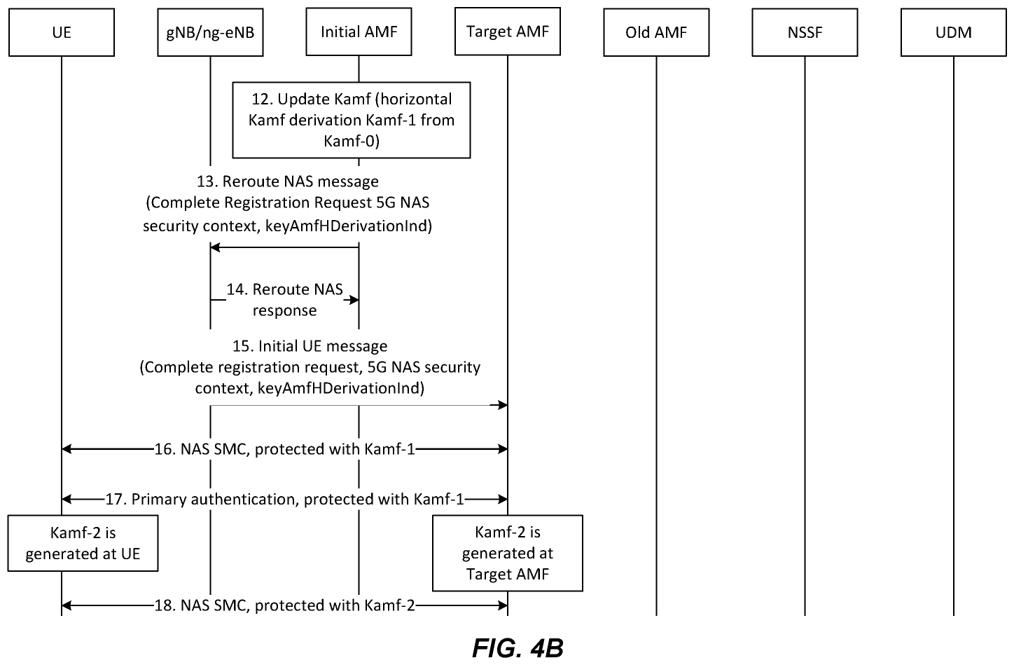

FIG. 7 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 7. For simplicity, the wireless network of FIG. 7 only depicts network QQ106, network nodes QQ160 and QQ160b, and wireless devices QQ110, QQ110b, and QQ110c. In practice, a wireless network may further include any additional elements suitable to support communication between wireless devices or between a wireless device and another communication device, such as a landline telephone, a service provider, or any other network node or end device. Of the illustrated components, network node QQ160 and wireless device QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and wireless device QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

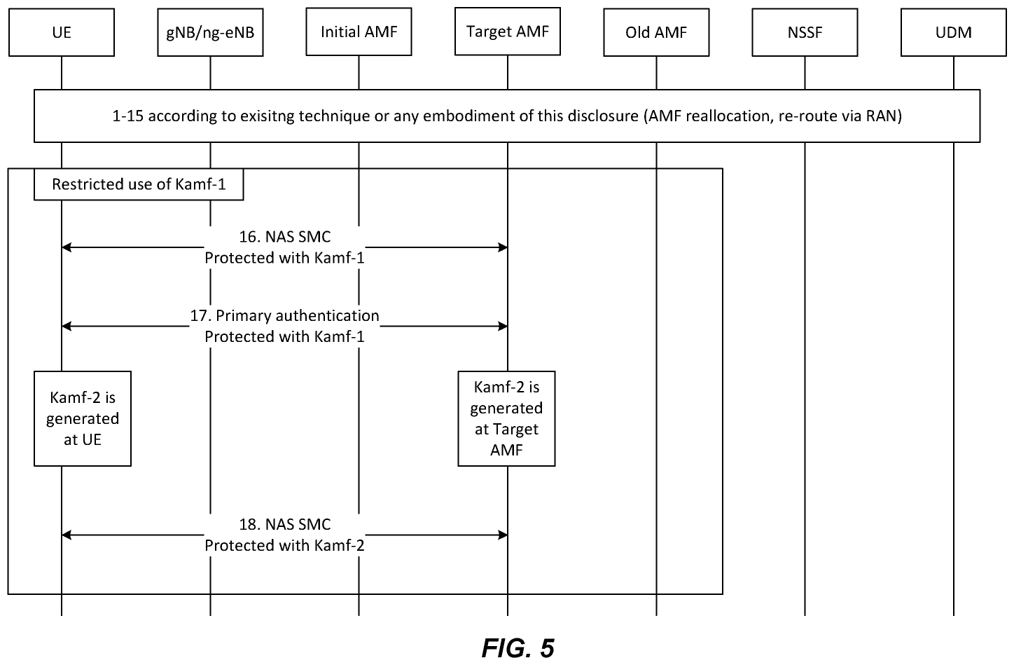

FIG. 8 illustrates an example network node QQ160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units.

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160 but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or wireless devices QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or wireless devices via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ192 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 8 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

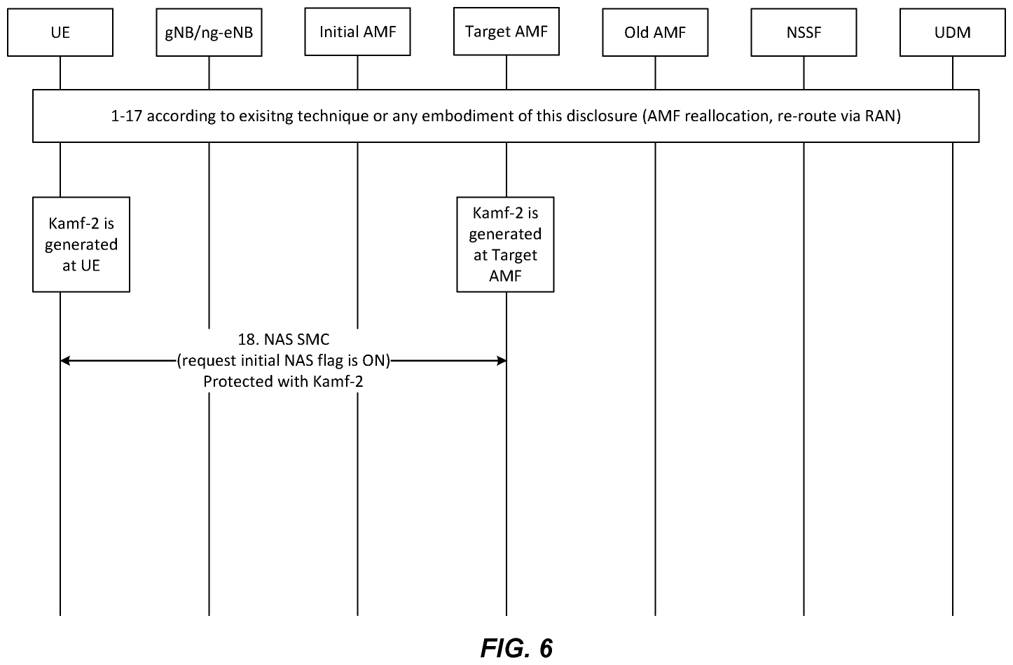

FIG. 9 illustrates an example wireless device QQ110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. Wireless device QQ110 may include multiple sets of one or more of the illustrated components for different wireless technologies supported by wireless device QQ110, such as, for example, GSM, WCDMA, LTE, NR, WiFi, WiMAX, or Bluetooth wireless technologies, just to mention a few. These wireless technologies may be integrated into the same or different chips or set of chips as other components within wireless device QQ110.

Antenna QQ111 may include one or more antennas or antenna arrays, configured to send and/or receive wireless signals, and is connected to interface QQ114. In certain alternative embodiments, antenna QQ111 may be separate from wireless device QQ110 and be connectable to wireless device QQ110 through an interface or port. Antenna QQ111, interface QQ114, and/or processing circuitry QQ120 may be configured to perform any receiving or transmitting operations described herein as being performed by a wireless device. Any information, data and/or signals may be received from a network node and/or another wireless device. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ112 is connected to antenna QQ111 and processing circuitry QQ120 and is configured to condition signals communicated between antenna QQ111 and processing circuitry QQ120. Radio front end circuitry QQ112 may be coupled to or a part of antenna QQ111. In some embodiments, wireless device QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or wireless devices via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device QQ110 components, such as device readable medium QQ130, wireless device QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of wireless device QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a wireless device may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of wireless device QQ110, but are enjoyed by wireless device QQ110 as a whole, and/or by end users and the wireless network generally.

Processing circuitry QQ120 may be configured to perform any determining, calculating, or similar operations (e.g., certain obtaining operations) described herein as being performed by a wireless device. These operations, as performed by processing circuitry QQ120, may include processing information obtained by processing circuitry QQ120 by, for example, converting the obtained information into other information, comparing the obtained information or converted information to information stored by wireless device QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with wireless device QQ110. Such interaction may be of many forms, such as visual, audial, tactile, etc. User interface equipment QQ132 may be operable to produce output to the user and to allow the user to provide input to wireless device QQ110. The type of interaction may vary depending on the type of user interface equipment QQ132 installed in wireless device QQ110. For example, if wireless device QQ110 is a smart phone, the interaction may be via a touch screen; if wireless device QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into wireless device QQ110 and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from wireless device QQ110, and to allow processing circuitry QQ120 to output information from wireless device QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, wireless device QQ110 may communicate with end users and/or the wireless network and allow them to benefit from the functionality described herein.

Auxiliary equipment QQ134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. wireless device QQ110 may further comprise power circuitry QQ137 for delivering power from power source QQ136 to the various parts of wireless device QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case wireless device QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of wireless device QQ110 to which power is supplied.

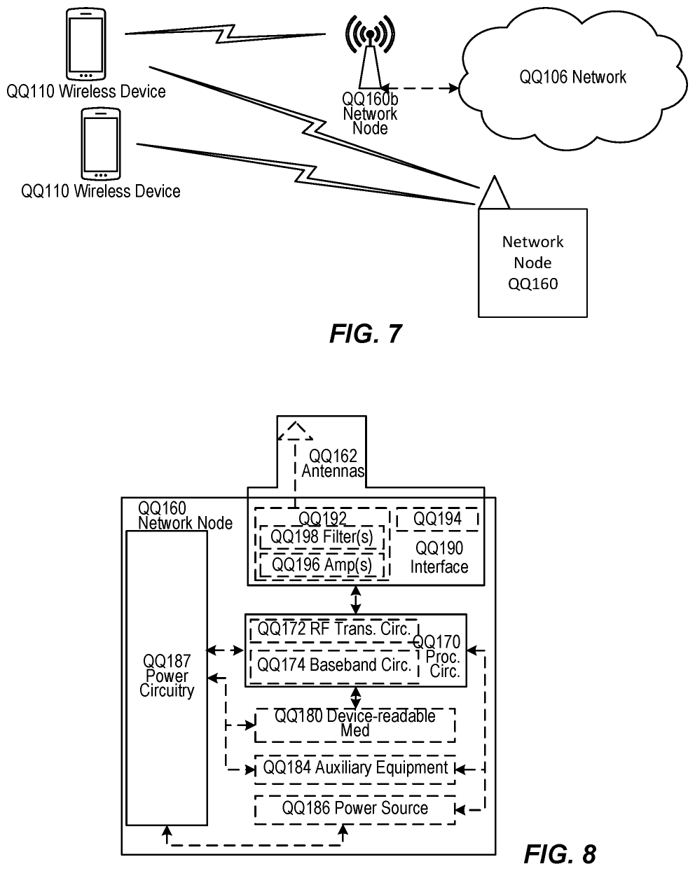

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ2200 may be any UE identified by the 3^{rd} Generation Partnership Project (3GPP), including a NB-IoT UE, a machine type communication (MTC) UE, and/or an enhanced MTC (eMTC) UE. UE QQ200, as illustrated in FIG. 8, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 10 is a UE, the components discussed herein are equally applicable to a wireless device, and vice-versa.

In FIG. 10, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. 10, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another wireless device, UE, or base station of a radio access network (RAN) according to one or more communication protocols, such as IEEE 802.QQ2, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

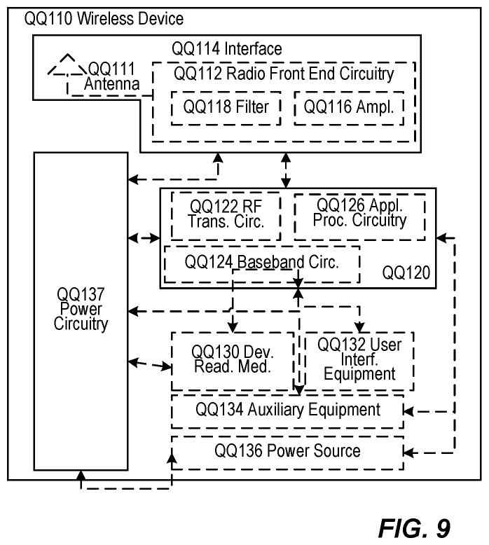

FIG. 11 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. 11, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. 11.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signaling can be affected with the use of control system QQ3230 which may alternatively be used for communication between the hardware nodes QQ330 and radio units QQ3200.

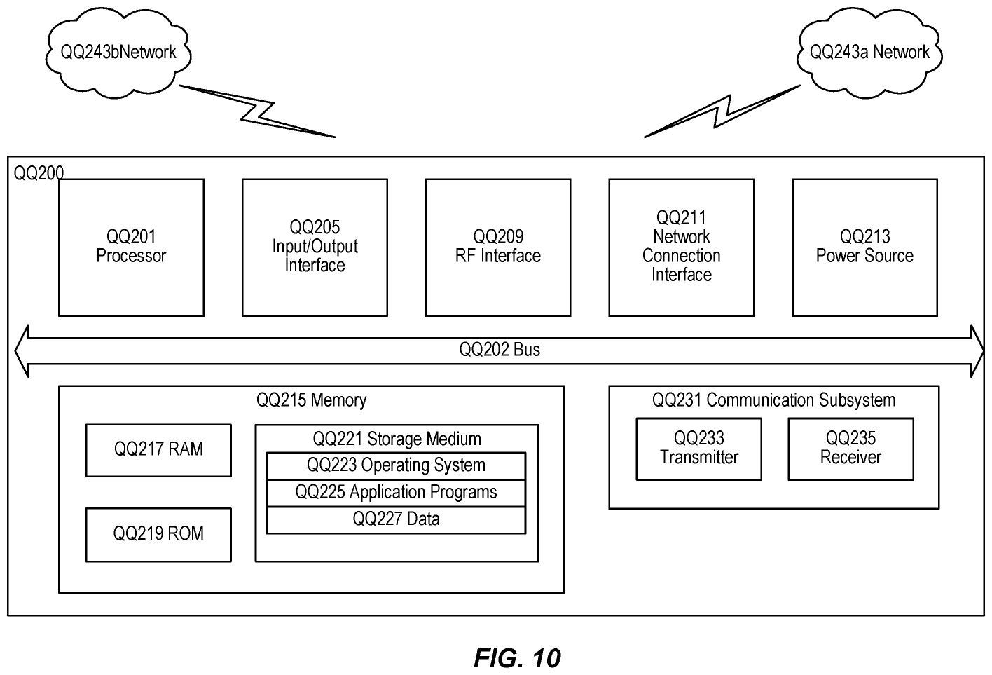

FIG. 12 illustrates a telecommunication network connected via an intermediate network to a host computer in accordance with some embodiments.

With reference to FIG. 12, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 12 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

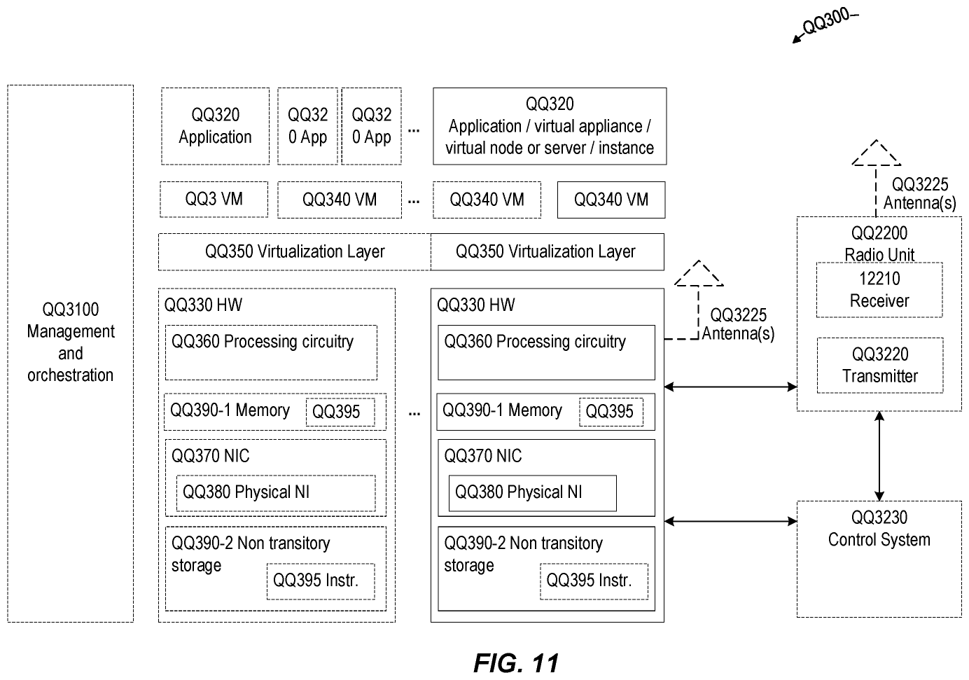

FIG. 13 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 13. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 13) served by base station QQ520. Communication interface QQ526 may be configured to facilitate connection QQ560 to host computer QQ510. Connection QQ560 may be direct or it may pass through a core network (not shown in FIG. 13) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. 13 may be similar or identical to host computer QQ430, one of base stations QQ412a, QQ412b, QQ412c and one of UEs QQ491, QQ492 of FIG. 12, respectively. This is to say, the inner workings of these entities may be as shown in FIG. 13 and independently, the surrounding network topology may be that of FIG. 12.

In FIG. 13, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

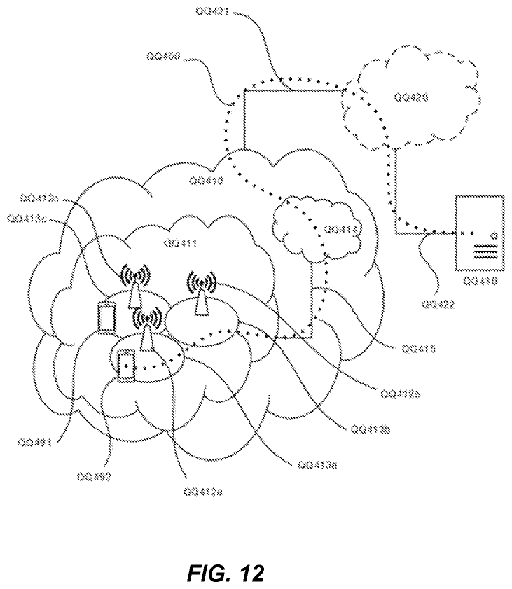

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

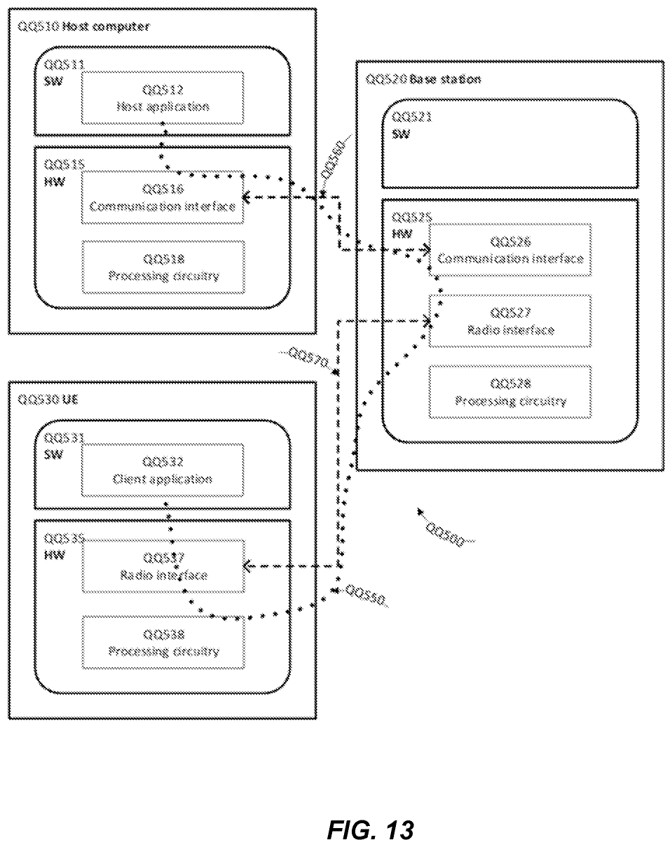

FIG. 18 depicts a method by a wireless device, according to certain embodiments. At step L02, the wireless device identifies that an AMF relocation procedure with re-route via a RAN node is being performed for the wireless device. At step L04, the wireless device generates a key associated with a primary authentication of the wireless device. At step L06, the wireless device uses the key for performing a NAS SMC procedure with a first network node operating as a target AMF. The use of the key by the wireless node is restricted such that the wireless device is restricted from using the key for at least one procedure other than the NAS SMS procedure with the first network node operating as the target AMF.

In a particular embodiment, the key is a Kamf.

In a particular embodiment, the wireless device receives, from the first network node, a first message comprising a NAS SMC message. In a further particular embodiment, the AMF relocation procedure is identified by the wireless device based on the first message.

In a further particular embodiment, the AMF relocation procedure is identified by the wireless device based on a content of the first message.

In a further particular embodiment, the AMF relocation procedure is identified by the wireless device based on a type of the first message.

In a further particular embodiment, the wireless device receives a second message comprising a primary authentication message.

In a particular embodiment, the AMF relocation procedure is identified by the wireless device based on the primary authentication message being received after the first message comprising the NAS SMC message.

In a particular embodiment, the AMF relocation procedure is identified by the wireless device based on the primary authentication message being received before a threshold amount of time has lapsed after the NAS SMC message was received.

In a particular embodiment, the first network node comprises a gNodeB (gNB) or Next Generation eNodeB (ng-eNB).

In a particular embodiment, the first network node comprises a core network node.

In a particular embodiment, the wireless device sets a count to a value and refuses to accept a third message associated with the key based on the count being at the value.

In a further particular embodiment, the value comprises a maximum value for the count.

In a further particular embodiment, the third message comprises a NAS message.

In a particular embodiment, the wireless device is restricted from using the key for any procedure other than the NAS SMS procedure.

In a particular embodiment, the wireless device comprises a user equipment (UE).

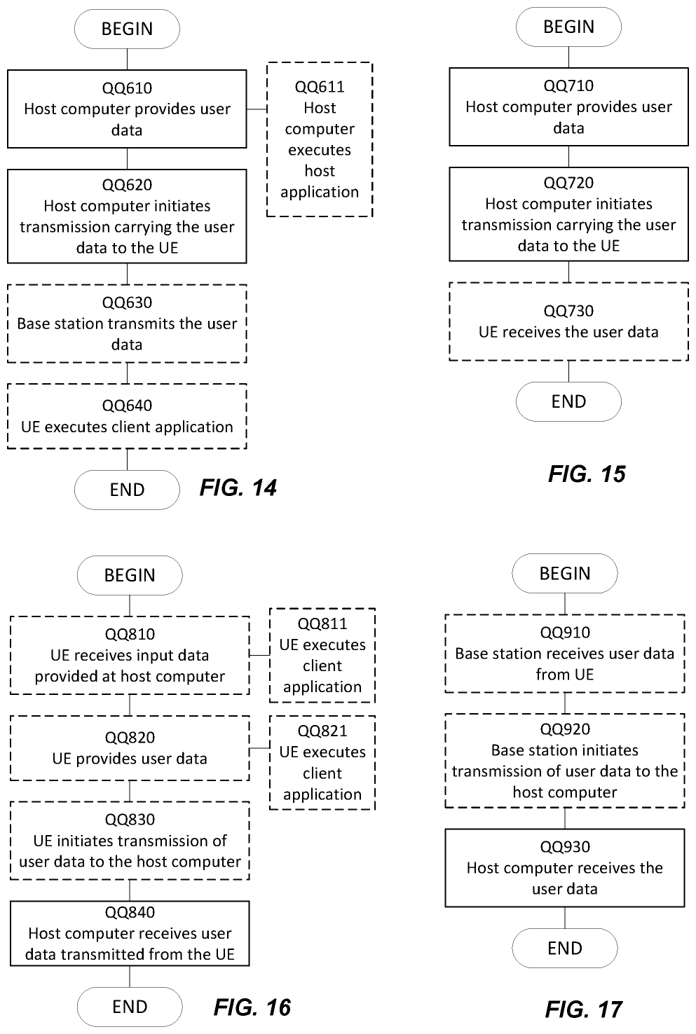

FIG. 19 illustrates a schematic block diagram of a virtual apparatus M00 in a wireless network (for example, the wireless network shown in FIG. 7). The apparatus may be implemented in a wireless device or network node (e.g., wireless device QQ110 or network node QQ160 shown in FIG. 7). Apparatus M00 is operable to carry out the example method described with reference to FIG. 18 and possibly any other processes or methods disclosed herein. It is also to be understood that the method of FIG. 18 is not necessarily carried out solely by apparatus M00. At least some operations of the method can be performed by one or more other entities.

Virtual Apparatus M00 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause identifying module M10, generating module M20, using module M30, and any other suitable units of apparatus M00 to perform corresponding functions according one or more embodiments of the present disclosure.

According to certain embodiments, identifying module M10 may perform certain of the identifying functions of the apparatus M00. For example, identifying module M10 may identify that an AMF relocation procedure with re-route via a RAN node is being performed for the wireless device.

According to certain embodiments, generating module M20 may perform certain of the generating functions of the apparatus M00. For example, generating module M20 may generate a key associated with a primary authentication of the wireless device.

According to certain embodiments, using module M20 may perform certain of the using functions of the apparatus M00. For example, using module M20 may use the key for performing a NAS SMC procedure with a first network node operating as a target AMF. The use of the key by the wireless node is restricted such that the wireless device is restricted from using the key for at least one procedure other than the NAS SMS procedure with the first network node operating as the target AMF.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

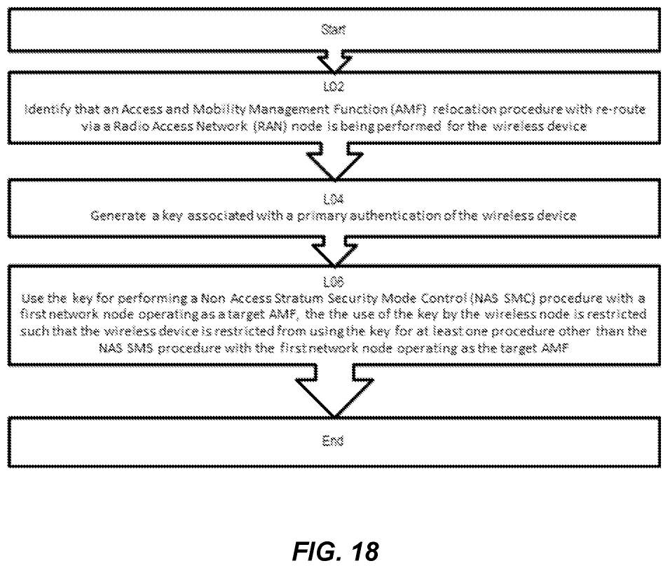

FIG. 20 depicts a method by a first network node operating as a target AMF, according to certain embodiments. At step NO2, the first network node generates a key associated with a primary authentication of the wireless device. At step N04, the first network node uses the key for performing a Non Access Stratum Security Mode Control (NAS SMC) procedure. The use of the key by the first network node is restricted such that the first network node is restricted from using the key for at least one procedure other than the NAS SMS procedure.

In a particular embodiment, the key is a Kamf.

In a particular embodiment, the first network node, receives, from the wireless device, a first message associated with an AMF relocation procedure from a source AMF to the first network node operating as the target AMF. The key is generated in response to receiving and/or based on the first message from the wireless device.

In a particular embodiment, the first network node receives, from a second network node, a second message and identifies the AMF relocation procedure based on the second message received from the second network node.

In a particular embodiment, the AMF relocation procedure is identified based on a content of the second message.

In a further particular embodiment, the second message comprises at least one of a security context, an indicator indicating that the first network node is to derive the key.

In a further particular embodiment, the AMF relocation procedure is identified based on a type of the second message.

In a further particular embodiment, the type of the second message is an initial user equipment message.

In a further particular embodiment, the second network node comprises a gNodeB (gNB) or Next Generation eNodeB (ng-eNB).

In a further particular embodiment, the second node comprises a core network node.

In a particular embodiment, the first network node sets a count to a value and refuses to accept a third message based on the count being at the value.

In a further particular embodiment, the value comprises a maximum value for the count.

In a further particular embodiment, the third message comprises a NAS message.

In a particular embodiment, the first network node is restricted from using the key for any procedure other than the NAS SMS procedure.

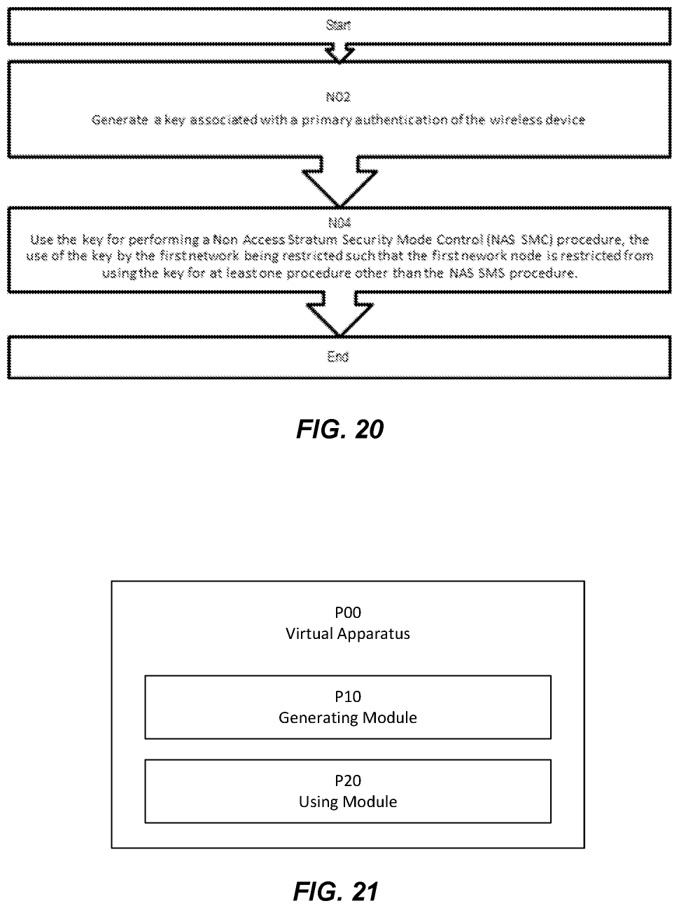

In a particular embodiment, the first network node may additionally or alternatively perform any of the steps or embodiments described below with regard to FIG. 22.

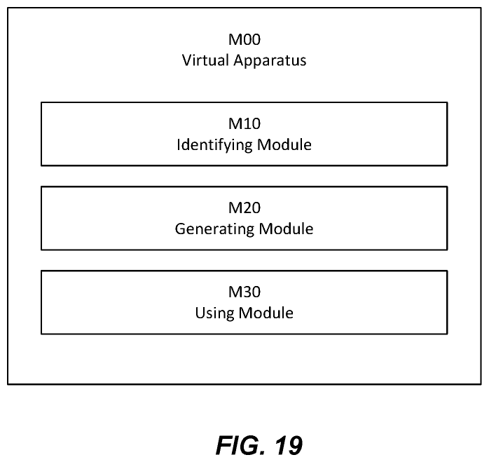

FIG. 21 illustrates a schematic block diagram of a virtual apparatus P00 in a wireless network (for example, the wireless network shown in FIG. 7). The apparatus may be implemented in a wireless device or network node (e.g., wireless device QQ110 or network node QQ160 shown in FIG. 7). Apparatus P00 is operable to carry out the example method described with reference to FIG. 20 and possibly any other processes or methods disclosed herein. It is also to be understood that the method of FIG. 20 is not necessarily carried out solely by apparatus P00. At least some operations of the method can be performed by one or more other entities.

Virtual Apparatus P00 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause generating module P10, using module P20, and any other suitable units of apparatus P00 to perform corresponding functions according one or more embodiments of the present disclosure.

According to certain embodiments, generating module P10 may perform certain of the generating functions of the apparatus P00. For example, generating module P10 may generate a key associated with a primary authentication of the wireless device.

According to certain embodiments, using module P20 may perform certain of the using functions of the apparatus P00. For example, using module P20 may use the key for performing a NAS SMC procedure. The use of the key by the first network node is restricted such that the first network node is restricted from using the key for at least one procedure other than the NAS SMS procedure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

FIG. 22 depicts another method by a first network node operating as a target AMF, according to certain embodiments. At step S02, the first network node receives, from a wireless device, a first message associated with an AMF relocation procedure from a source AMF to the first network node operating as the target AMF. At step S04, the first network node receives, from the source AMF, a second message associated with the AMF relocation procedure. At step S06, the first network node uses and/or determines to use the first message rather than the second message to construct a response message to the wireless device.

In a particular embodiment, the first message comprises an indicator, and wherein the first network node determines to use the first message from the wireless device rather than the second message from the source AMF to construct the response message.

In a further particular embodiment, the indicator comprises a request initial NAS flag.

In a further particular embodiment, the first message comprises a NAS SMC message.

In a particular embodiment, the second message comprises an initial user equipment (UE) message.

In a further particular embodiment, the initial UE message comprises at least one of a complete registration request, a 5G NAS security context, and a keyAmfHDerivationInd.

In a particular embodiment, the source AMF is associated with a second network node.

In a further particular embodiment, the second network node comprises a gNodeB (gNB) or Next Generation eNodeB (ng-eNB).

In a further particular embodiment, the first network node comprises a gNodeB (gNB) or Next Generation eNodeB (ng-eNB).

In a particular embodiment, the first network node determines to use the first message rather than the second message to construct the response message based on the first message.

In a particular embodiment, the first network node constructs the response message based on the first message rather than the second message.

In a particular embodiment, the first network node transmits the response message to the wireless device.

In a particular embodiment, the first network node may additionally or alternatively perform any of the steps or embodiments described above with regard to FIG. 20.

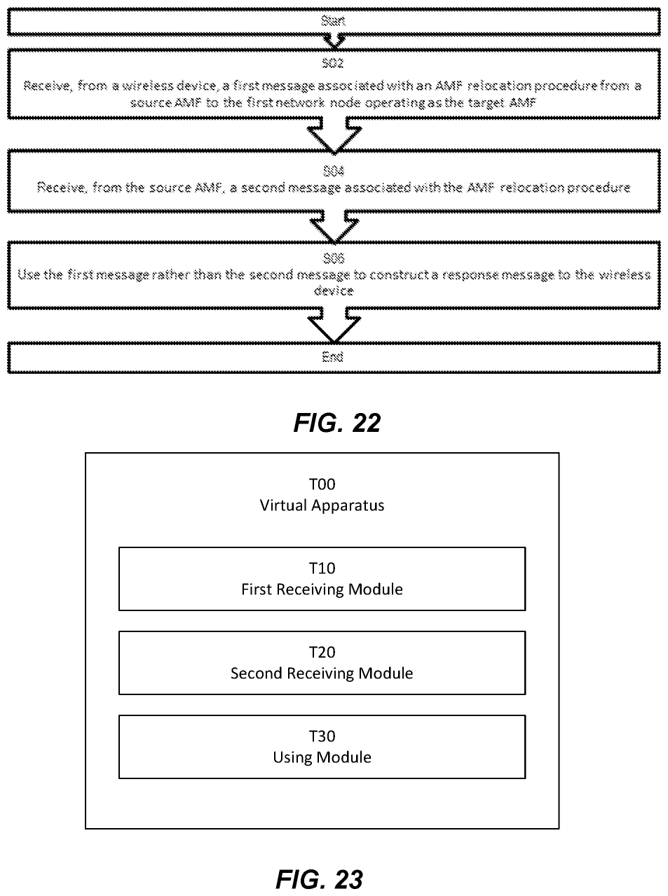

FIG. 23 illustrates a schematic block diagram of a virtual apparatus T00 in a wireless network (for example, the wireless network shown in FIG. 7). The apparatus may be implemented in a wireless device or network node (e.g., wireless device QQ110 or network node QQ160 shown in FIG. 7). Apparatus T00 is operable to carry out the example method described with reference to FIG. 20 and possibly any other processes or methods disclosed herein. It is also to be understood that the method of FIG. 20 is not necessarily carried out solely by apparatus T00. At least some operations of the method can be performed by one or more other entities.

Virtual Apparatus T00 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first receiving module T10, second receiving module T20, using module T30, and any other suitable units of apparatus T00 to perform corresponding functions according one or more embodiments of the present disclosure.

According to certain embodiments, first receiving module T10 may perform certain of the receiving functions of the apparatus T00. For example, first receiving module T10 may receive, from a wireless device, a first message associated with an AMF relocation procedure from a source AMF to the first network node operating as the target AMF.

According to certain embodiments, second receiving module T20 may perform certain other of the receiving functions of the apparatus T00. For example, second receiving module T20 may receive, from the source AMF, a second message associated with the AMF relocation procedure.

According to certain embodiments, using module T20 may perform certain of the using functions of the apparatus T00. For example, using module T20 may use the first message rather than the second message to construct a response message to the wireless device.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method performed by a wireless device comprising:
identifying that an Access and Mobility Management Function (AMF) relocation procedure with re-route via a Radio Access Network (RAN) node is being performed for the wireless device;
generating a key associated with a primary authentication of the wireless device; and
using the key for performing a Non Access Stratum Security Mode Control (NAS SMC) procedure with a first network node operating as a target AMF, and
wherein the use of the key by the wireless node is restricted such that the wireless device is restricted from using the key for at least one procedure other than the NAS SMS procedure with the first network node operating as the target AMF.

2. The method of claim 1, wherein the key is a K_{AMF}.

3. The method of claim 1, further comprising:
receiving, from the first network node, a first message comprising a NAS SMC message.

4. The method of claim 3, wherein the AMF relocation procedure is identified by the wireless device based on the first message.

5. The method of claim 3, wherein the AMF relocation procedure is identified by the wireless device based on a content of the first message.

6. The method of claim 3, wherein the AMF relocation procedure is identified by the wireless device based on a type of the first message.

7. The method of claim 3, further comprising receiving a second message comprising a primary authentication message.

8. The method of claim 7, wherein the AMF relocation procedure is identified by the wireless device based on the primary authentication message being received after the first message comprising the NAS SMC message.

9. The method of claim 8, wherein the AMF relocation procedure is identified by the wireless device based on the primary authentication message being received before a threshold amount of time has lapsed after the NAS SMC message was received.

10. The method of claim 1, wherein the first network node comprises a gNodeB (gNB) or Next Generation eNodeB (ng-eNB).

11. The method of claim 1, wherein the first network node comprises a core network node.

12. The method of claim 1, further comprising:
setting a count to a value; and
refusing to accept a third message associated with the key based on the count being at the value.

13. The method of claim 12, wherein the value comprises a maximum value for the count.

14. The method of claim 12, wherein the third message comprises a NAS message.

15. The method of claim 1, wherein the wireless device is restricted from using the key for any procedure other than the NAS SMS procedure.

16. The method of claim 1, wherein the wireless device comprises a user equipment (UE).

17. A wireless device comprising processing circuitry configured to perform the method of claim 1.

18. (canceled)

19. A computer program product comprising a computer program, the computer program comprising instructions which when executed on a computer perform the method of claim 1.

20. A non-transitory computer readable medium storing instructions which when executed by a computer perform the method of claim 1.

21. A method performed by a first network node operating as a target Access and Mobility Management Function (AMF), the method comprising:
generating a key associated with a primary authentication of the wireless device; and
using the key for performing a Non Access Stratum Security Mode Control (NAS SMC) procedure, and
wherein the use of the key by the first network node is restricted such that the first network node is restricted from using the key for at least one procedure other than the NAS SMS procedure.

22.-90. (canceled)
